(19) United States
(12) Patent Application Publication
(10) Pub. No.: US 2020/0274308 A1
(43) Pub. Date: Aug. 27, 2020

(54) Method of Manufacturing Electric Wire with Waterproof Plug

(71) Applicant: Yazaki Corporation, Tokyo (JP)

(72) Inventor: Sanae Kato, Makinohara-shi (JP)

(73) Assignee: Yazaki Corporation, Tokyo (JP)

(21) Appl. No.: 16/751,479

(22) Filed: Jan. 24, 2020

(30) Foreign Application Priority Data
Feb. 25, 2019 (JP) 2019-031674

(51) Int. Cl. H01R 43/00; H01R 13/52; H01R 43/05

(52) U.S. Cl. CPC H01R 43/005; H01R 43/05; H01R 13/5205

(57) ABSTRACT

A method of manufacturing an electric wire with a waterproof plug, the method including a first process of forming a notch in an insulation coating at a position that is away from a tip edge of the electric wire by a predetermined length, for stripping off the insulation coating of the tip edge side from that position, a second process of inserting the tip of the electric wire with the notch formed in the insulation coating in the first process into the waterproof plug, and attaching the waterproof plug on the outer periphery of the insulating coating so that the position where the notch is formed is located on the front side of the waterproof plug, and after the second process, a third process of stripping off the insulation coating on the front side of the notch to form the exposed conductor portion.

### CROSS REFERENCE TO RELATED APPLICATIONS

This application is based on and claims priority from Japanese patent application No. 2019-031674 filed on Feb. 25, 2019, the entire contents of which are incorporated herein by reference.

### BACKGROUND OF THE INVENTION

### 1. Technical Field

The present disclosure relates to a method of manufacturing an electric wire with a waterproof plug, in which the waterproof plug to be incorporated in the waterproof connector is attached to a tip of the electric wire in advance.

### 2. Background Art

For example, when assembling a waterproof connector, a rubber waterproof plug is attached to an outer periphery of the tip of the wire, and a terminal fitting is connected to the tip of the electric wire. The waterproof plug is crimped to an insulation-coated portion of the electric wire by the terminal fitting. Next, the terminal fitting is inserted into a terminal accommodating chamber of a connector housing, with which the waterproof plug is pushed into the terminal accommodating chamber, such that the waterproof plug is brought into close contact with an inner wall surface of the terminal accommodating chamber. Thus, the waterproof plug is used to close a gap between the inner wall surface of the connector housing and the electric wire to ensure waterproof performance. In this case, the general practice is that a small waterproof plug molded as a single product is attached to an outer periphery of the insulation coating at the tip of the coated electric wire.

In the case of attaching the waterproof plug to the tip of the electric wire and then connecting the terminal fitting thereto as described above, prior to connecting the terminal fitting, it is necessary to strip off the insulation coating of the electric wire at the front side of the waterproof plug to provide an exposed conductor portion. As a method of manufacturing an electric wire with a waterproof plug, in which an exposed conductor portion is provided at the tip of the electric wire, for example, a method having a procedure as shown in FIGS. 4A and 4B has been considered.

In this method, as shown in FIG. 4A, from the tip of the electric wire W whose outer periphery of the conductor Wa is coated with an insulation coating Wb, the insulation coating Wb is stripped off so that an exposed conductor portion Wa1 having a predetermined length is formed at a tip edge We of the electric wire W. Next, as shown in FIG. 4B, the tip of the electric wire W, from which the insulation coating Wb is stripped off, is inserted into a tubular waterproof plug 10 such that the waterproof plug 10 is attached to the outer periphery of the insulation coating Wb on the near side of the exposed conductor portion Wa1 .

However, since this method strips off the insulation coating Wb to form the exposed conductor portion Wa1 and then inserts the tip of the electric wire W into the waterproof plug 10, there is a possibility that a plurality of conducting wires in a bundle of a conductor (core wire) Wa are separated, resulting in a frayed wire Wa3 or the like. When the frayed wire Wa3 is left as is, there is a problem that a defect is likely to occur in the subsequent process.

Patent Document JP-A-2005-323484 discloses a method of stripping off the insulation coating without causing scattering of the conductor. In this method, a notch is formed in the insulation coating such that, when stripping off the insulation coating on the front side of the notch, the insulation coating to be stripped off is pulled out while being rotated.

However, although scattering at the time of stripping off the insulation coating is prevented, since the tip edge of the conductor may come into contact with the waterproof plug when inserted into the waterproof plug, a frayed wire or the like may occur, and thus it cannot be said that the problem is solved.

Therefore, the manufacturing by the method shown in FIGS. 5A to 5D is frequently performed in practice.

First, as shown in FIG. 5A, before forming the notch for stripping off the insulation coating, the tip of the electric wire W is inserted in the waterproof plug 10. At that time, as shown in FIG. 5B, in consideration of the processes subsequent to forming the notch, the waterproof plug 10 is moved to the near side (in the direction away from the tip of the electric wire W) from the fixing position where the waterproof plug 10 is actually fixed by crimping. That is, the waterproof plug 10 is attached at a position L1 (>L2=dimension at a fixing position) away from the tip edge We.

Next, as shown in FIG. 5C, a notch 3 is formed at a predetermined position of the insulation coating Wb, and the insulation coating Wb1 (Wb) on the front side from the notch 3 is stripped off. When the notch 3 is not sufficiently formed, at the time of stripping off, it is necessary to separate the electric wire W from the insulation coating Wb1 on the near side from the notch 3 with force, and for this purpose, it is necessary to shift the waterproof plug 10 to the front side from the fixing position where the waterproof plug 10 is fixed by crimping. Note that when the notch 3 is not sufficiently formed with respect to the insulation coating Wb, the insulation coating Wb may be torn off, thus resulting in torn pieces Wb3 on the cut surface of the insulation coating Wb.

Thus, when the waterproof plug 10 is in a position deviated from the fixing position, it cannot be crimped with the terminal fitting, and accordingly, as indicated by the arrow Z in FIG. 5D, the waterproof plug 10 is returned to the fixing position (position L2 from the tip edge), and then a terminal fitting 20 is crimped to the exposed conductor portion Wa1 of the electric wire W and the portion where the waterproof plug 10 is attached.

### SUMMARY

Meanwhile, although the method shown in FIGS. 5A to 5D can prevent the conductor Wa from being scattered, since the notch 3 is formed in the insulation coating Wb after the waterproof plug 10 is attached (see FIG. 5C), it is necessary to shift the position of the waterproof plug 10 from the fixing position for crimping and then accurately return the waterproof plug to the original fixing position after stripping off insulation coating Wb1 (see FIG. 5D). For this reason, there is a problem in that troublesome work processes are increased.

The present disclosure has been made in view of the circumstances described above, and an object of the present disclosure is to provide a method of manufacturing an electric wire with a waterproof plug, which does not cause the exposed conductor portion to be scattered and which can eliminate the trouble of having to reposition the waterproof plug.

In order to achieve the above object, a method of manufacturing an electric wire with a waterproof plug according to the present invention is characterized by the following (1) to (4).
(1) A method of manufacturing an electric wire with a waterproof plug, wherein an exposed conductor portion having a predetermined length away from a tip edge of the electric wire is prepared by, from a tip of the electric wire that is coated with an insulation coating on an outer periphery of a conductor, stripping off the insulation coating, and wherein a cylindrical waterproof plug is attached to an outer periphery of the insulation coating, the method comprising:

a first process of forming a notch in the insulation coating at a position that is away from the tip edge of the electric wire by a predetermined length, for stripping off the insulation coating of the tip edge side from that position;

a second process of inserting the tip of the electric wire with the notch formed in the insulation coating in the first process into the waterproof plug, and attaching the waterproof plug on the outer periphery of the insulating coating so that the position where the notch is formed is located on the front side of the waterproof plug; and

after the second process, a third process of stripping off the insulation coating on the front side of the notch to form the exposed conductor portion.
(2) The method of manufacturing an electric wire with a waterproof plug according to above (1), including,

in the second process, performing, with the waterproof plug being positioned and held by a jig, positioning of the waterproof plug and the electric wire in the axial direction by inserting a tip of the electric wire into the waterproof plug and moving the tip edge of the electric wire to hit against an abutting wall provided on the jig.
(3) The method of manufacturing an electric wire with a waterproof plug according to above (1), including,

in the first process, forming, as the notch, an all-round notch that is continuous over the entire circumference of the insulation coating.
(4) The method of manufacturing an electric wire with a waterproof plug according to above (3), including,

in the first process, forming the all-round notch in the insulation coating by allowing a cutting edge of the cutter, which is slid in a direction perpendicular to the axial direction of the electric wire, to be cut into the insulation coating, and in that state, rotating at least one of the cutter or the electric wire around an axis of the electric wire.

According to the method of manufacturing the electric wire with a waterproof plug configured as described above in (1), the notch is formed in the insulation coating of the electric wire, and then the tip of the electric wire is inserted into the waterproof plug in the state before the insulation coating is stripped off. Therefore, there is no possibility that the conductor (core wire) is scattered at the time of inserting the tip of the electric wire into the waterproof plug. Further, since it is not necessary to form the notch in the insulation coating after the waterproof plug is attached, when the waterproof plug is attached at the fixing position in the electric wire from the beginning, there is no need to move the waterproof plug at a later stage. That is, while it is important to position and hold the waterproof plug at the fixing position when the terminal is crimped, by positioning the waterproof plug at the fixing position during the second process of inserting the tip of the electric wire into the waterproof plug, it is not necessary to adjust the position of the waterproof plug in the subsequent process, thereby improving the workability.

According to the method of manufacturing an electric wire with a waterproof plug configured as described above in (2), by further abutting the tip edge of the electric wire inserted into the waterproof plug to hit against the abutting wall, the waterproof plug may be easily and accurately attached to a predetermined position away from the tip edge of the electric wire.

According to the method of manufacturing an electric wire with a waterproof plug configured as described above in (3), by forming an all-round notch on the insulation coating of the electric wire in the first process, the insulation coating may be separated cleanly only by lightly pulling the insulation coating on the front side of the notch, thereby easily stripping off the insulation coating on the front side of the notch by hand.

According to the method of manufacturing an electric wire with a waterproof plug configured as described above in (4), the all-round notch may be easily formed in the insulation coating by rotating at least one of the cutter or the electric wire.

According to the present disclosure, the notch is formed in the insulation coating of the electric wire, and then the tip of the electric wire is inserted into the waterproof plug in the state before the insulation coating is stripped off. Therefore, there is no possibility that the conductor (core wire) is scattered at the time of inserting the tip of the electric wire into the waterproof plug. Since it is not necessary to form the notch in the insulation coating after the waterproof plug is attached, when the waterproof plug is attached at the fixing position of the electric wire from the beginning, there is no need to move at a later stage. In other words, the waterproof plug is positioned at the fixing position at the time of inserting the tip of the electric wire into the waterproof plug, and it is not necessary to adjust the position of the waterproof plug in the subsequent process, thereby reducing the work processes and improves the production efficiency.

The present invention has been described briefly above. Further, details of the present invention will be clarified further by reading a mode for carrying out the invention (hereinafter, referred to as “embodiment”.) described below with reference to attached drawings.

### BRIEF DESCRIPTION OF THE DRAWINGS

FIGS. 1A to 1D are diagrams for explaining a method of manufacturing an electric wire with a waterproof plug according to an embodiment of the present disclosure, in which FIGS. 1A to 1D are diagrams for explaining each process.

FIGS. 2A to 2D are diagrams for explaining a method of manufacturing an electric wire with a waterproof plug according to an embodiment of the present disclosure, in which FIGS. 2A to 2C are diagrams for explaining procedures for forming an all-round notch for the insulation coating of the electric wire, and FIG. 2D is a cross-sectional diagram taken along the line A-A of FIG. 2B.

FIG. 3 is a schematic diagram of a jig according to an embodiment of the present disclosure.

FIGS. 4A and 4B are explanatory diagrams of a method of manufacturing an electric wire with a waterproof plugin in the related art, in which FIGS. 4A and 4B are diagrams for explaining each process.

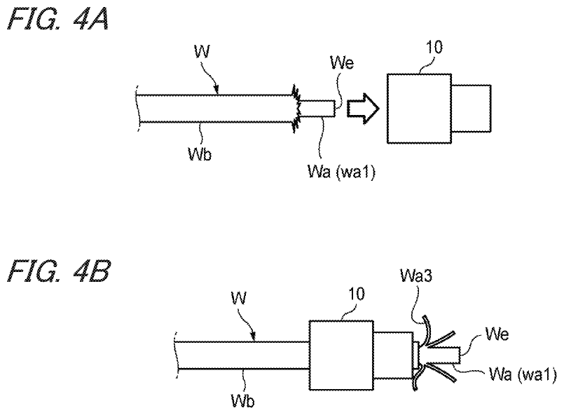

FIGS. 5A to 5D are diagrams for explaining a method of manufacturing an electric wire with a waterproof plug, which is generally performed in a related art, in which FIGS. 5A to 5D are diagrams for explaining each process.

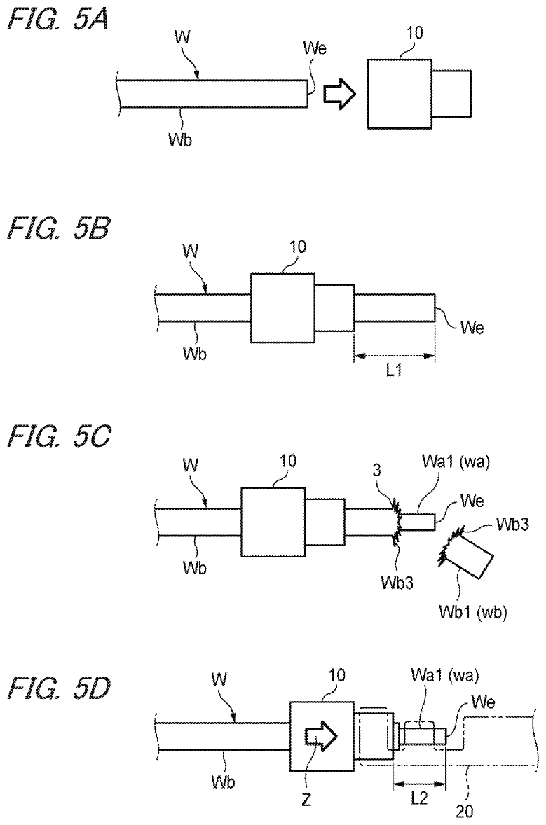

### DETAILED DESCRIPTION OF EMBODIMENTS

Specific embodiments relating to the present disclosure will be described below with reference to the drawings.

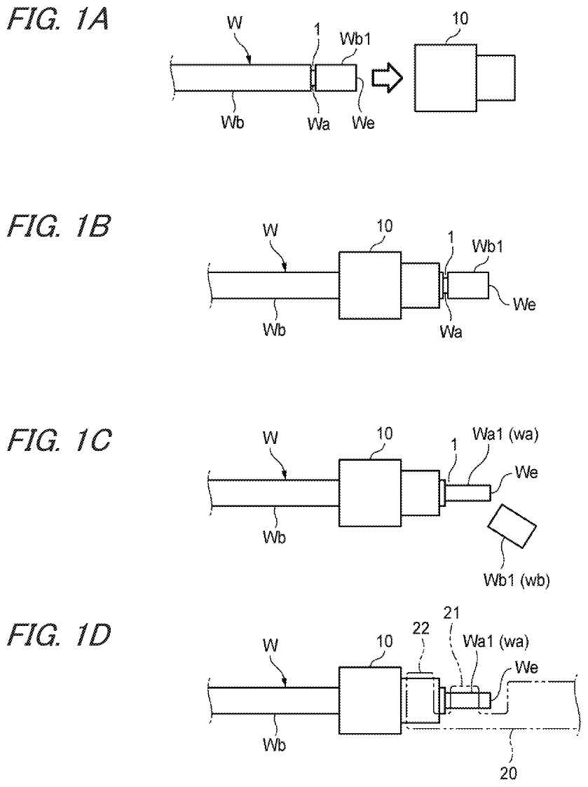

FIGS. 1A to 1D are diagrams for explaining a method of manufacturing an electric wire with a waterproof plug according to an embodiment of the present disclosure, in which FIGS. 1A to 1D are diagrams for explaining each process.

As shown in FIGS. 1A to 1D, the method is a method of manufacturing an electric wire with a waterproof plug, in which an exposed conductor portion Wa1 having a predetermined length away from a tip edge We of an electric wire W is prepared by, from a tip of the electric wire W that is coated with an insulation coating Wb on an outer periphery of a conductor (core wire) Wa, stripping off the insulation coating Wb, and in which a cylindrical waterproof plug 10 is attached to an outer periphery of the insulation coating Wb on the near side (a side which is away from the tip edge We) of the exposed conductor portion Wa1 .

The waterproof plug 10 is a small, one-piece rubber component that is attached to the outer periphery of the tip of the electric wire W when a waterproof connector is assembled. The waterproof plug 10 is attached to the electric wire W, at a near position that is away from the tip edge We by a predetermined length. The tip of the electric wire W protruding from the waterproof plug 10 is stripped off, and a terminal fitting 20 is connected to the exposed conductor portion Wa1 thereof. Then, the terminal fitting 20 is inserted into a terminal accommodating chamber of a connector housing (not shown), with the waterproof plug 10 being also pushed into the terminal accommodating chamber, such that the waterproof plug is brought into close contact with an inner wall surface of the terminal accommodating chamber. As a result, the gap between the inner wall surface of the connector housing and the electric wire W is closed with the waterproof plug 10 to thus ensure the waterproof performance. The waterproof plug 10 is a cylindrical component and includes an electric wire insertion hole penetrating from a rear end surface to a front end surface along a central axis.

As shown in FIG. 1A, the method of manufacturing the electric wire with the waterproof plug prepares, in a first process, a notch 1 in the insulation coating Wb at a position that is away from the tip edge We of the electric wire W by a predetermined length, for stripping off the insulation coating Wb1 on the front side of that position of the notch 1. In an example, the notch is formed as an all-round notch 1 that is continuous over the entire circumference of the insulation coating Wb of the electric wire W.

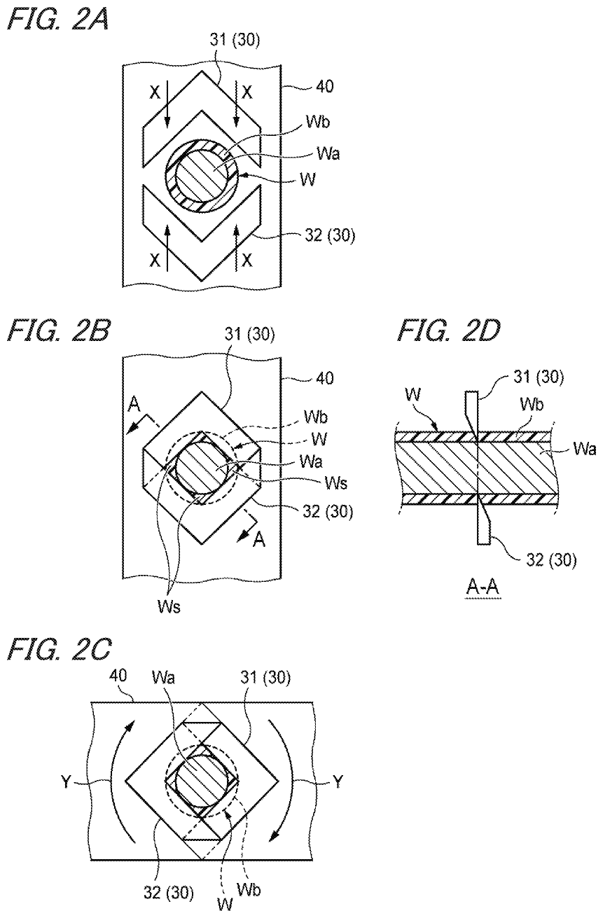

For example, a method of forming the all-round notch 1 includes, as shown in FIG. 2A, preparing a coating removing device including a cutter 30 to be slid in a direction perpendicular to the axial direction of the electric wire W (in the direction of the arrow X), and cutting into the insulation coating Wb of the electric wire W with a cutting edge of the cutter 30, as shown in FIGS. 2B and 2D. In this state, as indicated by an arrow Y in FIG. 2C, the cutter 30 is rotated around the axis of the electric wire W, so that the all-round notch 1 may be formed in the insulation coating Wb.

In the examples of FIGS. 2A to 2D, by sliding a pair of V-shaped cutters 31 and 32 facing with each other, the cutting edges of the cutters 31 and 32 are cut into the insulation coating Wb of the electric wire W (see FIGS. 2B and 2D). When the cutting edges of the V-shaped cutters 31 and 32 are simply cut into the insulation coating Wb, an uncut portion Ws is generated. Therefore, a head portion 40 that supports the cutters 31 and 32 is rotated by 90°. Accordingly, it is possible to form a notch also in the insulation coating Wb of the uncut portion by the cutting edges of the cutters 31 and 32, and as a result, it is possible to form an all-round notch 1.

Although FIGS. 2A to 2D show examples in which the cutter 30 is rotated, the electric wire W may be rotated or both the cutter 30 and the electric wire W may be rotated in a state in which the cutting edge of the cutter 30 is cut into the insulation coating Wb.

As described above, when the V-shaped cutters 31 and 32 are used, by changing an amount of sliding of the cutters 31 and 32 in accordance with a diameter of the electric wire W, it is possible to form the notch 1 having a required depth only in the insulation coating Wb regardless of the diameter.

As another method of forming the all-round notch 1, a cutter having a semicircular cutting edge corresponding to a diameter of the conductor Wa may be used. In any case, in the first process, the all-round notch 1 is formed.

Next, as shown in FIG. 1 B, in a second process, the tip of the electric wire W having the all-round notch 1 formed in the insulation coating Wb in the first process, and having the insulation coating Wb1 remaining on the front side of the notch 1, is inserted into the tubular waterproof plug 10. At this time, the waterproof plug 10 is attached at a fixing position for crimping on an outer periphery of the insulation coating Wb of the electric wire W so that the position where the notch 1 is formed is located on the front side of the waterproof plug 10.

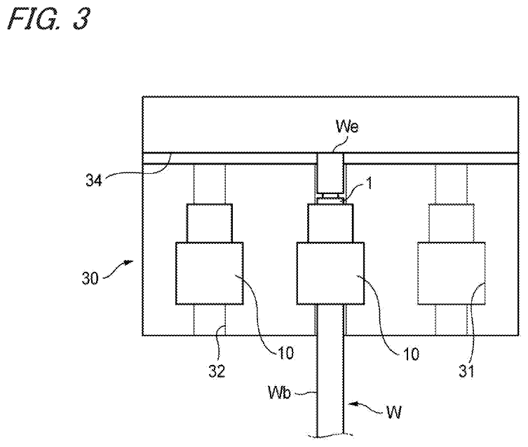

In this second process, the waterproof plug 10 is positioned and held by a positioning hole 31 of a jig 30 as shown in FIG. 3. Then, the electric wire W with the notch 1 formed in the insulation coating Wb in the first process is advanced forward along a groove 32, inserted into the waterproof plug 10, and further passed through until the tip edge We of the electric wire W hits the abutting wall 34 provided in the jig 30. As a result, positioning of the waterproof plug 10 and the electric wire W in the axial direction is performed.

Next, in a third process shown in FIG. 10, the insulation coating Wb1 on the front side of the notch 1 is stripped off to form the exposed conductor portion Wa1. Then, to the tip of the electric wire with a waterproof plug manufactured in this way, a conductor crimping part 21 and a coating crimping part 22 of the terminal fitting 20 are crimped, as shown in FIG. 1D. When the coating crimping part 22 is crimped, the front half of the waterproof plug 10 positioned at the fixing position is also crimped at the same time, so that an electric wire with the waterproof plug 10 and the terminal fitting 20 is completed.

According to the method of manufacturing the electric wire with a waterproof plug described above, the notch 1 is formed in the insulation coating Wb of the electric wire W, and then the tip of the electric wire W is inserted into the waterproof plug 10 in the state before the insulation coating Wb1 is stripped off. Therefore, there is no possibility that the conductor (core wire) Wa is scattered at the time of inserting the tip of the electric wire W into the waterproof plug 10.

Since it is not necessary to form the notch 1 in the insulation coating Wb after the waterproof plug 10 is attached, the waterproof plug 10 can be attached at the fixing position in the electric wire W from the beginning, without a need to move it at a later stage. That is, while it is important to position and hold the waterproof plug 10 at the fixing position when the terminal fitting 20 is crimped, by positioning the waterproof plug 10 at the fixing position during the second process of inserting the tip of the electric wire W into the waterproof plug 10, it is not necessary to adjust the position of the waterproof plug 10 in the subsequent process, and this improves the workability.

In the second process, by further moving the tip edge of the electric wire W inserted into the waterproof plug 10 to hit against the abutting wall, the waterproof plug 10 may be easily and accurately attached to a predetermined position away from the tip edge of the electric wire W.

Further, by forming an all-round notch 1 on the insulation coating Wb of the electric wire W in the first process, the insulation coating Wb1 may be separated cleanly only by lightly pulling the insulation coating Wb1 on the front side of the notch 1, thereby easily stripping off the insulation coating Wb1 on the front side of the notch 1 by hand.

The all-round notch 1 may be easily formed in the insulation coating Wb by rotating at least one of the cutter 30 or the electric wire W.

Here, the characteristics of the method of manufacturing an electric wire with a waterproof plug according to the embodiment of the present disclosure described above are briefly summarized and listed below in [1] to [4], respectively.

[1] A method of manufacturing an electric wire with a waterproof plug, in which an exposed conductor portion Wa1 having a predetermined length away from a tip edge We of the electric wire W is prepared by, from a tip of the electric wire W that is coated with an insulation coating Wb on an outer periphery of a conductor Wa, stripping off the insulation coating Wb, and in which a cylindrical waterproof plug 10 is attached to an outer periphery of the insulation coating Wb, the method including a first process of forming a notch 1 in the insulation coating Wb1 at a position that is away from the tip edge We of the electric wire W by a predetermined length, for stripping off the insulation coating Wb1 of the tip edge We side from that position, a second process of inserting the tip of the electric wire W with the notch 1 formed in the insulation coating Wb in the first process into the waterproof plug 10, and attaching the waterproof plug 10 on the outer periphery of the insulating coating Wb so that the position where the notch 1 is formed is located on the front side of the waterproof plug 10, and after the second process, a third process of stripping off the insulation coating Wb on the front side of the notch 1 to form the exposed conductor portion Wa1 .

[2] The method of manufacturing an electric wire with a waterproof plug according to [1] described above, in which, in the second process, the method performs, with the waterproof plug 10 being positioned and held by a jig 30, positioning of the waterproof plug 10 and the electric wire W in the axial direction by inserting a tip of the electric wire W into the waterproof plug 10 and moving the tip edge of the electric wire W to hit against an abutting wall 34 provided on the jig.

[3] The method of manufacturing an electric wire with a waterproof plug according to [1] described above, in which, in the first process, the method forms, as the notch 1, an all-round notch 1 that is continuous over the entire circumference of the insulation coating Wb.

[4] The method of manufacturing an electric wire with a waterproof plug according to [3] described above, in which, in the first process, the method forms the all-round notch 1 in the insulation coating Wb by allowing a cutting edge of the cutter 30, which is slid in a direction perpendicular to the axial direction of the electric wire W, to be cut into the insulation coating Wb, and in that state, rotating at least one of the cutter 30 or the electric wire W around the axis of the electric wire W.

What is claimed is:

1. A method of manufacturing an electric wire with a waterproof plug, wherein an exposed conductor portion having a predetermined length away from a tip edge of the electric wire is prepared by, from a tip of the electric wire that is coated with an insulation coating on an outer periphery of a conductor, stripping off the insulation coating, and wherein a cylindrical waterproof plug is attached to an outer periphery of the insulation coating, the method comprising:
a first process of forming a notch in the insulation coating at a position that is away from the tip edge of the electric wire by a predetermined length, for stripping off the insulation coating of the tip edge side from that position;
a second process of inserting the tip of the electric wire with the notch formed in the insulation coating in the first process into the waterproof plug, and attaching the waterproof plug on the outer periphery of the insulating coating so that the position where the notch is formed is located on the front side of the waterproof plug; and
after the second process, a third process of stripping off the insulation coating on the front side of the notch to form the exposed conductor portion.

2. The method of manufacturing an electric wire with a waterproof plug according to claim 1, including,
in the second process, performing, with the waterproof plug being positioned and held by a jig, positioning of the waterproof plug and the electric wire in the axial direction by inserting a tip of the electric wire into the waterproof plug and moving the tip edge of the electric wire to hit against an abutting wall provided on the jig.

3. The method of manufacturing an electric wire with a waterproof plug according to claim 1, including,
in the first process, forming, as the notch, an all-round notch that is continuous over the entire circumference of the insulation coating.

4. The method of manufacturing an electric wire with a waterproof plug according to claim 3, including,
in the first process, forming the all-round notch in the insulation coating by allowing a cutting edge of the cutter, which is slid in a direction perpendicular to the axial direction of the electric wire, to be cut into the insulation coating, and in that state, rotating at least one of the cutter or the electric wire around an axis of the electric wire.
